(19) United States
(12) Patent Application Publication
(10) Pub. No.: US 2014/0020568 A1
(43) Pub. Date: Jan. 23, 2014

(54) Heat Exchanger For Fryer

(71) Applicants: Lee Lisheng Huang, Palo Alto, CA (US); Peter Raymond Palm, Danville, CA (US)

(72) Inventors: Lee Lisheng Huang, Palo Alto, CA (US); Peter Raymond Palm, Danville, CA (US)

(21) Appl. No.: 13/555,171

(22) Filed: Jul. 22, 2012

(51) Int. Cl. F28F 1/02; A47J 37/12

(52) U.S. Cl. CPC F28F 1/025; A47J 37/12
USPC 99/403; 165/132

(57) ABSTRACT

A novel tube heat exchanger is provided for a gas powered fryer where the cross-sectional area for flame passage decreases along the length of the tube. An exemplary tube heat exchanger has a spiral corrugated surface to have increase surface area, wherein a tapered spiral insert improves the interaction of the flame with the tube wall to improve the heat transfer. A split tube having flame passing cross-sectional area reduced along the direction of the flame flow improves interaction of the flame with the walls of the tubes and increases the surface area for better heat transfer.

### FIELD OF THE INVENTION

The invention relates generally to cooking equipment. In particular, the invention relates to heat transfer from a heating element to a fryer, more specifically from a flame source from combustion of natural gas.

### BACKGROUND

The deep fryer is a major cooking appliance in the commercial kitchen. They are typically used for cooking French fries, chicken, vegetables etc. In the cooking process, a tank of oil is heated up to about 350° F. and then food is put into the bath. Temperature drops after the food is put in the bath. The temperature of the oils needs to get back to the set temperature to perform the cooking. It is preferable to have quick recovery time after the food is put into the bath. To achieve a quick recovery time, a powerful burner is needed to do the job. However, achieving a quick recovery time with high efficiency is more challenging.

Tremendous efforts have been put made to improve the efficiency of the fryer. Technologies such as the infrared burners, pulsed burner and the recirculating tube have been tried to improve the fryer efficiency. Some of the technologies are good, albeit expensive. Energy efficient fryers on the market place are typically more expensive compared to the simpler and, therefore, less efficient fryers. At the moment, the efficiency of gas fryers ranges from 30% to 60%. The energy efficient fryer only takes about 5% market share due to its higher cost.

There are two major configurations for gas fryers on the market: one is a side fired configuration where flame is heating the sloped side walls of the tank; the other one is tube fired where flame is fired into tubes running through the tank to provide heat transfer to the oil in the tank. Many efforts have been made to improve the efficiency of the heat transfer. For example, U.S. Pat. No. 3,769,959 and U.S. Pat. No. 5,901,641 shows using baffles inside the tube. On the other hand U.S. Pat. No. 6,029,653 describes a design having a tube going back and forth, passing through the liquid multiple times to extend the path for the heat transfer. Similarly, U.S. Pat. No. 6,016,799 describes tubes with some chambers to allow turbulence in the tube to improve heat transfer. The multi-pass of flame in the tube usually requires a blower at the end of the tube to facilitate the flow of the flame to pass through the 180 degree turns in the tube. The blower needs electrical power to run and is mechanical in nature, resulting in higher maintenance cost.

There is still a need to improve efficiency cost effectively to allow wide application of energy efficient fryers to achieve energy saving on a large scale.

### SUMMARY OF THE INVENTION

In a gas fryer, heat from a hot flame is transferred to the oil via the wall of the tank or tubes in the tank. The heat transfer coefficient from gas to a solid typically is small, affecting the efficiency of the heat transfer. A way to improve the heat transfer is to increase the surface area of the solid. Similar to the solution the current author provides for cookware in U.S. Pat. No. 8,037,602, the method here is to increase the surface area of the tank wall or tube wall.

It is an objective of the present invention to improve the efficiency of a fryer by increasing the surface area of the side wall, or the tube wall, of a fryer tank to improve the heat transfer from the flame to the tank.

It is another objective to provide a design for the increase of surface so that there is a low cost manufacturing process to achieve it.

It is another objective to improve the efficiency while keeping the simple overall system design of the basic fryer for ease of maintenance.

It is another objective to create a helical movement of the flame inside the tube of a fryer to improve the heat transfer from the flame to the tube wall, therefore to the liquid in the fryer tank.

It is another objective to improve the baffle design to facilitate the helical movement of the flame to create better heat transfer from the flame to the tube wall.

It is another objective to provide a core to the tube that will force the flame to flow in channels along the surface.

It is another objective to provide a tube whose cross-section is reduced along the length to promote interaction between flame and wall of the tube.

It is another objective to provide a split tube to promote heat transfer.

It is another objective to provide an insert in the tube to reduce the cross-section area to promote the heat transfer to the wall the tube.

It is another objective to provide a mean to reduce the radiation loss from the fryer tank.

### BRIEF DESCRIPTION OF THE FIGURES

Objectives and advantages disclosed herein will be understood by reading the following detailed description in conjunction with the drawing, in which:

FIG. 1 a prior art side fired fryer and tube fired fryer

FIG. 2 a side fired fryer with finned side walls

FIG. 3 a tube fired fryer with finned tubes

FIG. 4 fin orientations inside the tube

FIG. 5 a side fired fryer with corrugated side walls

FIG. 6 a tube fired fryer with corrugated tube walls

FIG. 7 a tube with helical corrugated side walls

FIG. 8 a spiral insert for helical corrugated tube

FIG. 9 a rectangular tube with a transitional insert with varying cross-section

FIG. 10 a rectangular split tube with varying cross-section

FIG. 11 a top view of a corrugated tube for a cylindrical fryer tank

### DETAILED DESCRIPTION

Although the following detailed description contains many specifics for the purpose of illustration, anyone of ordinary skill in the art will readily appreciate that many variations and alterations may be made.

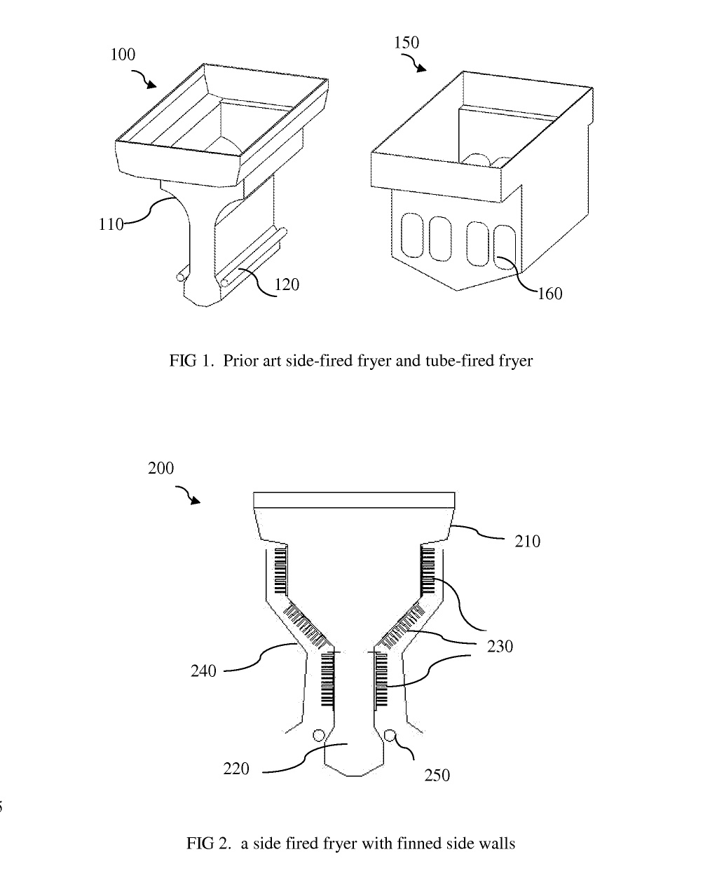

The deep fryer is a major cooking appliance in commercial kitchens. In gas powered fryers, there are two major heating arrangements: side fired heating and tube fired heating. For the side fired heating, the bottom wall of the tank is tilted to have larger area than otherwise horizontally flat bottom. It is shown in FIG. 1. Fryer tank 100 has two side walls 110 sloping down toward the center. A multiport burner 120 is placed under the sloped portion of the side wall. The heat transfer from the flame takes place at the slope portion of the tank. A second major approach is to use a tube fired configuration, where there are three to five tubes running across the tank. Tank 150 in FIG. 1 is a tube fired configuration. The tubes 160 are disposed running through the liquid across the tank 150. An array of burners (not shown) shoots flame horizontally into the tubes which will run out from the other side of the tank. The tubes are placed close to the bottom of the tank, therefore immersed in the liquid in the tank. A flame fires in the tube from the inlet at the front wall of the tank, passes through the tube and exits from the outlet at the back wall of the tank. Heat is transferred from the flame to the liquid via the tube wall as the flame passing through the tube.

It is known in the art that the efficiency of the fryer is not high, at about 30-40%. The efficiency is limited mainly by the heat transfer from the flame to the tank. One way to improve the heat transfer is to increase the surface area of the tank. It is proposed in this invention to increase the surface area of the side wall and the tubes in the fryer tank to improve the energy efficiency of a gas fryer.

One embodiment of such increase in surface is shown in FIG. 2, where the fryer tank 200 is configured for a side fired application. The side wall 210 is tapered to provide a narrow region 220 called cold zone to trap the food fragments. The metal fin structure 230 is constructed on the side wall to provide an extended surface for better heat transfer. Typically the wall 210 is made of stainless steel and fins can be made of aluminum. The impact bonding process can be used to attach aluminum to stainless steel. The process making of the tank 200 with fins is as following: impact bond aluminum onto a sheet of stainless steel; create the fins with the machining; fold the stainless steel sheet to form the tank shape; and then weld to complete the tank. The fins 220 in the figure are configured to run horizontally on the wall, while they can run at any angle downward along the wall as well.

To further improve the heat transfer, it is preferred to form a channel to confine the flame to travel in proximity of the surface of the tank. To do so, a confining plate 240 is placed close to the finned wall 210 of the tank to confine the flow of the hot flame between the wall and the plate. There are two major effects from the confining plate 240 that contribute to better efficiency. One is confining the flame to have good contact with the finned wall 210 to fully utilize the extended area in the corrugated structure to improve convention heat transfer. The second is reducing the infra-red radiation lost from the wall 210. The radiated power is proportional to the 4^{th} power of the temperature. Let T₁ to be the temperature of the tank and the T₂ is the ambient temperature in Kelvins, the radiation loss proportional to T₁²-T₂², let the temperature of T3 be the temperature of the confining plate. At equilibrium, their relationship is established T₁²-T₃²=T₃²-T₂² . For a fryer at 350° F. which is T₁=176° C., the ambient temperature T₂ is 25° C., the T₁ can be calculated to be 85.7° C. The radiation lost from the tank is therefore calculated to be reduced by 28% due to the presence of the confining plate. This, with the improvement in convention heat transfer will translate to 5-10% of improvement in the overall efficiency. Therefore, this plate is useful even without the fins on the wall of the tank. Preferably, the surface of the plate facing the tank will be roughened and treated to be dark to have good radiation properties while the other surface of this plate will be shiny to reduce radiation loss. The distance between the confining plate and the wall of the tank preferably to be in range of 0.25-2 inch.

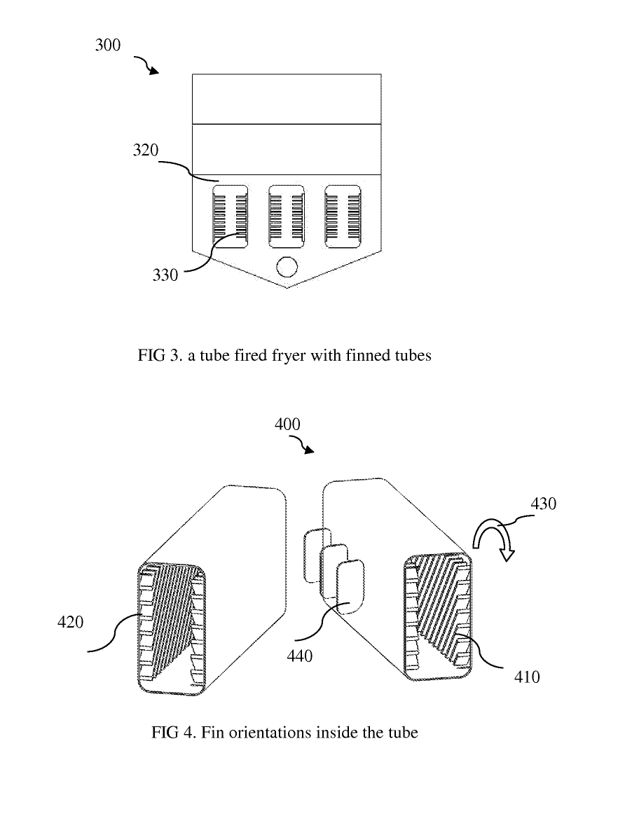

An embodiment of fin structure in a tube fired fryer is shown in FIG. 3, where the fryer tank 300 has several tubes 310 running across. Inside each of the tube, there are metal fins 320 attached to the wall of the tube. The fins increase surface area for the tube, therefore improving the heat transfer. The process of making the fin can also be done via the impact bonding process: impact bond two pieces of aluminum to a sheet of stainless steel; create the fins on the aluminum pieces; fold the stainless sheet to form a tube; and weld the seam to complete the tube. It is also possible to cast iron tube with fins built inside the tube.

In FIG. 3, the direction of the fins is along the direction of the tube. It is preferable to have the fins running at an angle with the direction of the tube. The directions of the fins on two sides of the wall on the tube can be running as if part of a helix. For example in FIG. 4, in the tube 400, the direction of the right side of the fins 410 is at an angle with the tube direction, i.e. the flame comes in from the front will be guided downward on the right side, while the left side fins 420 are arranged such that the flame will be guided upward by the fin. Under the influence of this fin arrangement, the flame flow will start to swirl in a direction depicted by arrow 430 as it travels along the tube. The swirling movement of the flame increases the interaction between the flame and the tube wall to take advantage of the extended surface area, therefore improving the heat transfer. To further facilitate such swirling motion, a baffle 440 can be placed inside the tube to push the flow toward the wall of the tube. The shape of the 440 can be made similar to a fan blade to propel the flame flow in the direction of the fins. The angle between the fins and the tube direction needs to be adjusted such that it matches the flow speed of the flame coming out of the burner to achieve optimal heat transfer. The flame temperature is high, as it runs inside the tube it will tends to flow up again the top portion of the tube due to buoyancy. Therefore it is also preferable to place the baffle 440 close to the top of the tube to force the hot flame flow to come down to take advantage all the surface area of the tube. The periodic placement of the baffles 440 along the tube can be such that it matches the speed of the flow along the tube to effectively disperse the hot flame from the top portion of the tube throughout the tube to improve heat transfer.

When frying food on a fry pan, or making sauce in a sauce pot, the inside surface of the pot is preferred to be flat and smooth to be easy to clean. However in a deep fryer situation, the oil in the deep fryer is acting like a heat transfer medium to absorb and transfer heat to the food to be fried. There is no need for food to be in contact with the wall of the tank of a deep fryer, therefore the requirement of the flat surface can be relaxed. It is proposed here to produce an increase of surface on the tank by making a corrugated surface.

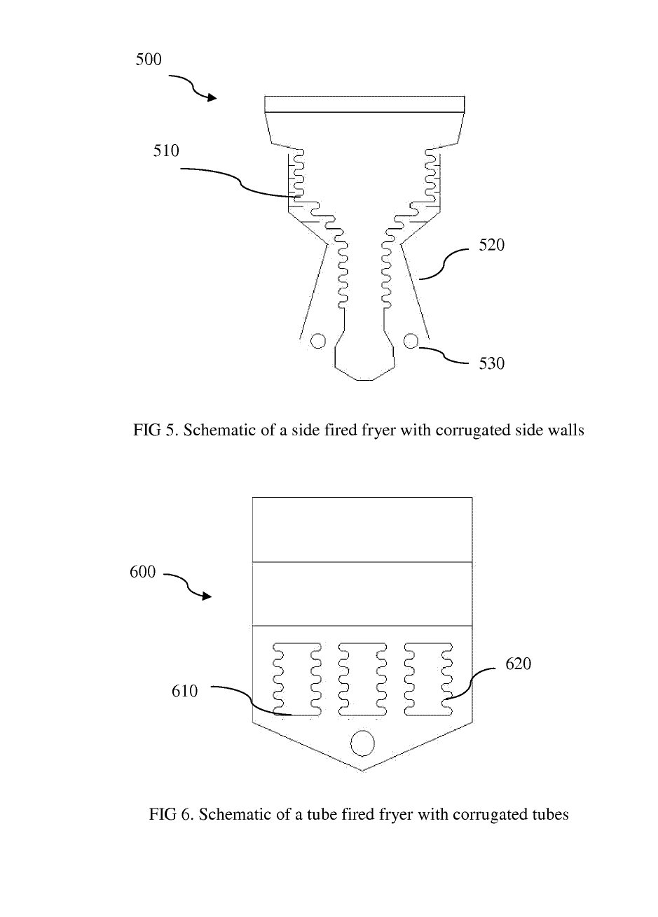

FIG. 5 shows a fryer 500 with a side fired configuration with a corrugated surface area 510 built on the side wall. The corrugations are in horizontal direction, while is also possible to arrange it to be along the downward direction of the wall. The corrugation shape is a semicircle in this case. The increase in area from flat surface is 1.56 times. If it is formed in square shape the increase of area will be 2 times. It is also possible to extend the corrugation depth some more to have bigger area increase ratio. There is a difference between the increase of the surface area by corrugated surface and by fins. The heat absorbed to the fin needs to conduct through the height of the fin to reach the body of the tank then to medium inside. While the increase surface area of corrugated wall is wall itself, the heat absorbed to this surface will directly be transferred to the medium inside the tank. For a same amount increase in surface area, the corrugated surface will have better heat transfer than the metal fin structure. For the corrugated surface, the medium inside the tank also experience the increase of the surface area, and the heat transfer from the corrugated wall to the medium inside also improved.

To further improve the heat transfer, it is preferred to confine the flame to flow closely to the surface of the tank. To do so, a confining plate 520 is place close to the corrugated wall 510 of the tank and the region between the 520 and 510 is the channel. The flame from burner 530 will travel upwards along the space between the corrugated wall 510 and plate 520. As discussed in the fin case, the plate 520 helps to confine the flame to have better contact with the wall 510 to utilize the corrugated area; it also reduces the infrared radiation losses from the wall 510.

An embodiment of a corrugated tube fired tank is shown in FIG. 6. The tank 600 has a tube 610 running through. The wall of the tube has corrugated surface 620. The corrugated surface is shown formed on the large side of the tubes, while it can also be formed in all sides on the tube.

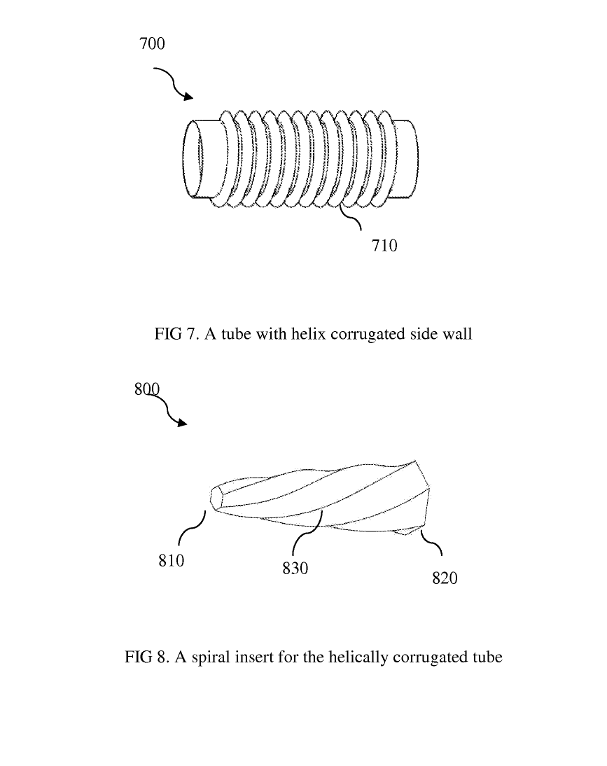

Preferably, the corrugated line is formed in helix shape to induce spiral movement in the flame flow. In FIG. 7, the corrugated line 710 form forms a helix around the tube 700. An array of baffles can also be placed inside along the tube. The baffle is placed in the top portion of the tube tilted in the direction to guide the flame to flow in the direction of the helix. The cross-section of the baffle is such that it is sufficiently large enough to force the flame to flow mainly along the corrugated surface of the tube, and yet will not reduce the flow rate too much to require a blower to pump air through. The efficiency can be maximized by optimizing the corrugating depth, the helix direction, the cross-section area of the baffle, and tilting angle of the baffle. Due to the traveling wave nature of the flame flow, the corrugation of the tube has two functions: it increases the surface area for heat exchange (need to guide the flame to swirl to take full advantage of the increase surface area); and it also creates turbulence in the flame flow in the direction of the tube.

As hot flame travels down the tube, it cools down and shrinks its volume. The energy carried by the hot flame is proportional to the temperature. A typical flame from a natural gas burner is about 1200° C. If the target efficiency of the fryer is 60%, then the flame temperature exiting the fry tube will be about 316° C. As the temperature decreases, the volume/pressure of the gas flow is reduced or interaction to the wall reduces. Therefore it is suggested here to have the baffles designed in such a way that the cross-sectional area of the baffle increases in the length direction of the tube. For example the cross-section of the baffle can increase to 60% of the cross-section area of the tube at the end of the tube. The increase of the baffle area will decrease the cross-section area for the flame to pass through. This will effectively limit the flame to flow more along the corrugated area.

Alternatively, the baffle can be in the form of a tapered insert in the length of the tube to force the flame to flow in a region close to the tube surface. The tapered shape of the insert is like a bullet, increasing in cross-section along its length. The increase in cross-section of the insert along the length will ensure the flame will continue to have good interactions with the tube surface. Such a spiral insert is shown in FIG. 8. The insert 800 has a length slightly shorter than the tube length. The cross-sectional size of the head 810 is smaller than the size of the tail 820, and there is a spiral feature 830 to force a spiral movement of the flame around the tube wall the insert is placed in. The cross-sectional size profile along the length of the insert, the spiral pitch, and size of the 830 will be adjusted to maximize the efficiency of the heat exchange from the tube wall.

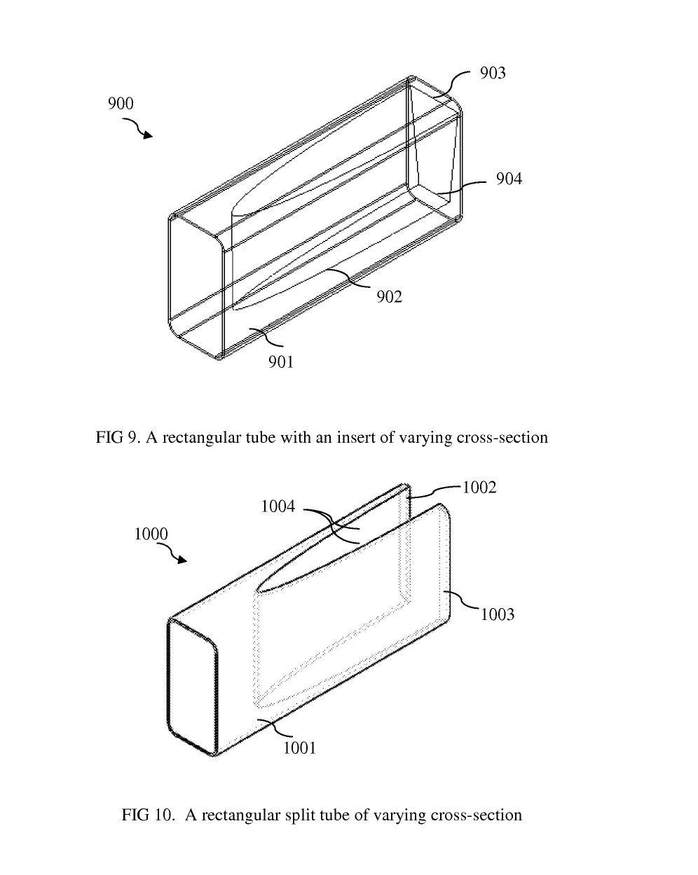

A typical fryer tube has a cross-section is close to an oval or rectangle. These elongated shapes provide more surface area than a circular or a square one for a given cross-sectional area. As the hot flame travels along the length of the tube, it will start to cool down. The cooled portion of the flame will travel in the lower portion of the tube. So the cross-section of the insert for this elongated tube will be in general having a larger top portion, and the cross-sectional area will increase along the length of the tube. An implementation of such insert is shown in FIG. 9. It is an insert 902 placed inside the tube 901. The top edge 903 of the wedge is larger than the lower edge of the wedge 904 to force the flame to flow to other areas of the tube. The cross-sectional area of the insert increases along the length of the tube, reducing the flame passing cross-sectional area. The wall of the tube 901 can be corrugated, dimpled or having other perturbations to create turbulence.

Various different types of baffles, such as a series of baffles in 404 in FIG. 4, can also be used to reduce the flame passing cross-sectional area. The effective area of the baffles increases along the path to reduce the flame passing area.

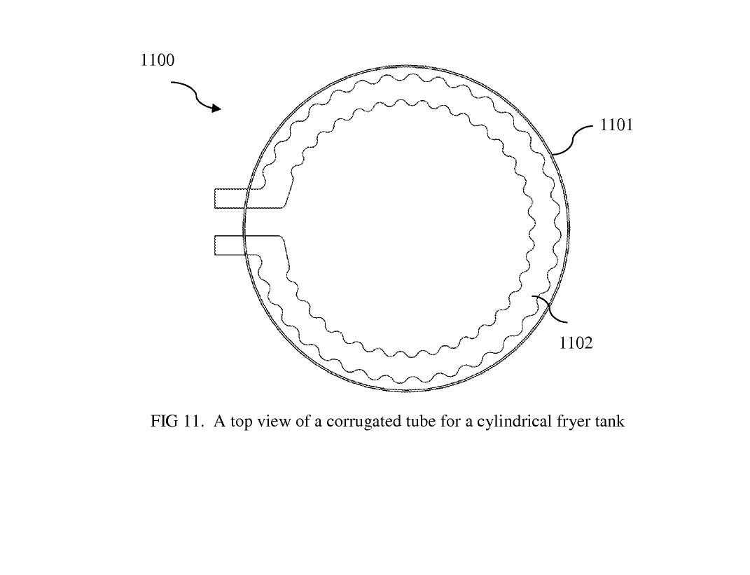

In a further embodiment of this concept, it is also possible to create a split tube for the fryer to match cooling down of the flame flow along the tube. As shown in FIG. 11, tube 1000 has one inlet tube 1001 splitting into two exit tubes 1002 and 1003. The cross-section at the exit end of tubes 1002 and 1003 combined is smaller than the cross-section of the inlet end of 1001. At the junction of the splitting, the turbulent is also created to promote heat transfer. The cross-section reduction along the length should match the cooling of the flame. The splitting of the tube has created walls 1004 in contact with liquid, creating more surface area for heat transfer than otherwise a single tube. The cross-section of two split tubes also decreases along the path. The reduction of the cross-section will maintain the good interaction between flame and the wall of the tubes. It is possible to have multiple splits along the path. Better yet, corrugations or other perturbation features are formed on the wall of the tubes.

The fryer tank can also be in cylindrical in shape, e.g a turkey fryer. A tube is placed running just inside the cylindrical wall to provide heating to the bulk of the liquid circumference by the tube. A corrugated tube can be used in this configuration to improve the fryer efficiency. FIG. 11 shows a cylindrical fryer 1100 with a cylindrical tank body 1101. There is a corrugated tube 1102 circulating inside the cylindrical tank.

Instead of using a conventional gas burner to fire into the tube, it is possible to use an infra-red burner inside the tube. The advantage of the IR burner is that the combustion happens at higher temperatures, and high temperature radiation can help heat transfer from the wall to the liquid. The corrugated surface area of the tube can improve the IR absorption to the tube, reducing the reflection of the IR from the tube back to the burner. It also improves the heat transfer from the tube to the liquid.

The other advantage of using corrugated structure is that it can be formed conveniently by sheet metal folding, deep drawing, stamping, hydroforming, spinning and other sheet metal processes. The readily available manufacturing processes will enable high efficiency fryers at a reasonable low cost to enable market penetration of energy efficient fryers.

In operation, a burner will provide combustion to generate hot flame. The hot flame is fired into the tubes, or the side wall of the tank. The temperature of the liquid inside the tank is detected by temperature sensors such as thermal couples. A microprocessor is used to monitor the temperature of the liquid, to provide feedback to the burner to control the rate of the burner output to achieve efficient operation.

The same heat transfer improvement on the fryer can be easily adapted to equipment like pasta cookers, re-thermalizers. While a heating system of a pasta cooker, or re-thermalizer, is almost identical to a fryer, there is some difference in the tank. In operation, fresh water is added continuously to the pasta cooker to push the starch out by the overflow of the water. This constant inflow of cold water demands higher performance of the burner and the heat exchanger. The heat exchange configuration of current invention can help cope with this demand application. The thermal energy of the out flow of hot water can be recovered by adding a heat exchanger between the outflow and inflow of water.

It will be valued to those skilled in the art that the preceding examples are exemplary and not limiting. It is intended that all permutations, enhancements, equivalents, and improvements thereto, that are apparent to those skilled in the art, upon a reading of the specification and a study of the drawings are included within the true spirit and scope of the present disclosure. It is therefore intended that the following appended claims include all such modifications, permutations and equivalents that fall within the true spirit and scope of the present disclosure.

We claim:

1. A heat exchanger for a fryer system comprising:
a. a liquid holding tank;
b. a tube is disposed across the tank to allow a flame to flow through; wherein the cross-sectional area of the tube through which the flame passes decreases along its length.

2. A heat exchange of claim 1, wherein a tapered insert is placed inside a tube.

3. A heat exchange of claim 1, wherein a series of baffles is placed inside the tube, the effective area of the baffles increasing along the tube's length.

4. A heat exchanger of claim 1, wherein the tube splits into two tubes.

5. A heat exchanger of claim 2 wherein the cross-sectional area of the inlet is larger than that of the two outlets combined.

6. A heat exchanger for a fryer system comprising:
a. a liquid holding tank;
b. a tube is disposed across the tank allowing a flame to flow through, wherein the cross-sectional area of the tube through which the flame passes decreases along its length.
c. a corrugation is formed on the wall of the tube.

7. A heat exchanger of claim 5, wherein a tapered insert is placed inside the tube.

8. A heat exchanger for a fryer system having:
a. a liquid holding tank;
b. a tube disposed across the tank allowing a flame to flow through, which splits into two tubes.

9. A heat exchanger of claim 8, wherein the two split tubes further split into more tubes.

10. The heat exchanger of claim 8, wherein the cross-sectional area of the tube through which the flame passes decreases along its length.

11. A side fired gas fryer comprising:
a. a liquid tank with sloped sidewalls;
b. a burner disposed under the sloped wall to provide heat to the tank;
c. a flame confining plate placed in proximity of the tank wall, improving interaction of the flame with the tank walls while reducing radiation heat loss.

12. A side fired gas fryer of claim 11, wherein the distance between the confining plate and the side wall is less than 2 inches.
